(19) United States
(12) Patent Application Publication
(10) Pub. No.: US 2024/0330806 A1
(43) Pub. Date: Oct. 3, 2024

(54) METHOD, INFORMATION PROCESSING DEVICE, AND STORAGE MEDIUM

(71) Applicant: TOYOTA JIDOSHA KABUSHIKI KAISHA, Toyota-shi (JP)

(72) Inventors: Ryogo NONAKA, Kawasaki-shi (JP); Ai MIYATA, Hirakata-shi (JP); Keisuke OKAMOTO, Chofu-shi (JP); Yuka TAKIGUCHI, Fukaya-shi (JP); Nahoko SHIBANO, Tokyo (JP); Yuta SHISHIME, Tokyo (JP); Tsuyoshi OKADA, Nagoya-shi (JP); Shota KOMATSU, Kobe-shi (JP)

(73) Assignee: TOYOTA JIDOSHA KABUSHIKI KAISHA, Toyota-shi (JP)

(21) Appl. No.: 18/594,205

(22) Filed: Mar. 4, 2024

(30) Foreign Application Priority Data
Mar. 29, 2023 (JP) 2023-054197

(51) Int. Cl. G06Q 10/0631; G06Q 50/47

(52) U.S. Cl. CPC G06Q 10/06315; G06Q 50/47

(57) ABSTRACT

A method that is performed by an information processing device includes: acquiring biometric information of each of a plurality of spectators who is going to visit an event venue; and determining, based on the biometric information, an operation plan for one or more vehicles to transport the spectators to and/or from the event venue.

### CROSS-REFERENCE TO RELATED APPLICATION

This application claims priority to Japanese Patent Application No. 2023-054197 filed on Mar. 29, 2023, incorporated herein by reference in its entirety.

### BACKGROUND

### 1. Technical Field

The present disclosure relates to methods, information processing devices, and storage media.

### 2. Description of Related Art

Conventionally, the technology for transporting users who are going to visit an event venue is known in the art. For example, Japanese Unexamined Patent Application Publication No. 2022-080651 (JP 2022-080651 A) discloses acquiring event information for each user and relationships between users, creating groups based on the acquired information, and proposing a shared trip with the group.

### SUMMARY

There is room for improvement in technology for transporting users who are going to visit an event venue.

The present disclosure provides the technology for transporting users who are going to visit an event venue.

A method according to an aspect of the present disclosure is a method that is performed by an information processing device. The method includes: acquiring biometric information of each of a plurality of spectators who is going to visit an event venue; and determining, based on the biometric information, an operation plan for one or more vehicles to transport the spectators to or from the event venue, or to and from the event venue.

A storage medium according to an aspect of the present disclosure causes one or more computers to acquire biometric information of each of a plurality of spectators who is going to visit an event venue, and determine, based on the biometric information, an operation plan for one or more vehicles to transport the spectators to or from the event venue, or to and from the event venue.

An information processing device according to an aspect of the present disclosure is an information processing device including a control unit. The control unit is configured to acquire biometric information of each of a plurality of spectators who is going to visit an event venue, and determine, based on the biometric information, an operation plan for one or more vehicles to transport the spectators to or from the event venue, or to and from the event venue.

According to an aspect of the present disclosure, the technology for transporting users who are going to visit an event venue is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of a terminal device;

FIG. 3 is a block diagram showing a schematic configuration of an information processing device;

FIG. 4 is a block diagram showing a schematic configuration of a vehicle;

FIG. 5 is a flowchart showing the operation of the information processing device;

FIG. 6 is a flowchart showing a first example of a determination process that is performed by the information processing device; and

FIG. 7 is a flowchart showing a second example of the determination process that is performed by the information processing device.

### DETAILED DESCRIPTION OF EMBODIMENTS

An embodiment of the present disclosure will be described below.

### Overview of Embodiment

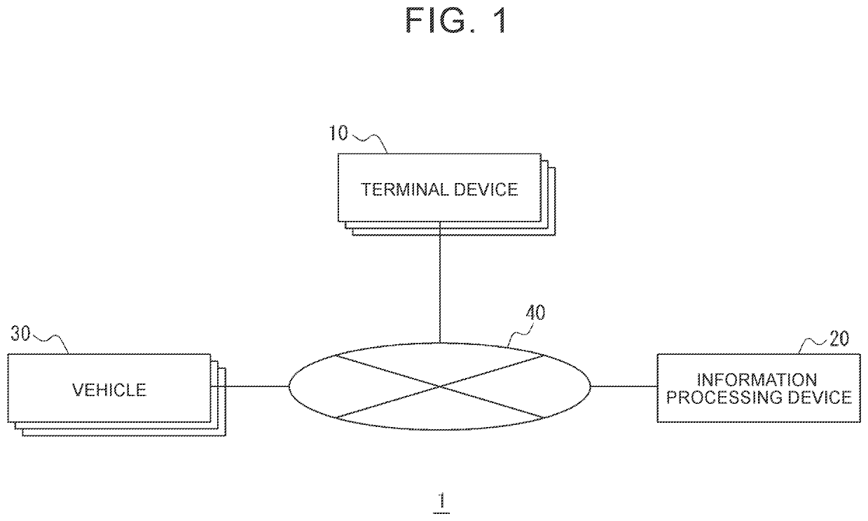

An overview of a system 1 according to an embodiment of the present disclosure will be given with reference to FIG. 1. The system 1 includes a plurality of terminal devices 10, an information processing device 20, and a plurality of vehicles 30. The terminal devices 10, the information processing device 20, and the vehicles 30 are connected to a network 40 including, for example, the Internet and a mobile communication network so that they can communicate with each other. In the present embodiment, the system 1 is used to determine an operation plan for the vehicles 30 to transport a plurality of spectators who is going to visit an event venue to the event venue. The event venue may be, but is not limited to, an arena, a stadium, or a festival venue.

The terminal devices 10 are any computers that are used by users. Examples of the terminal devices 10 include general-purpose computers such as smartphones and tablets, wearable terminals such as smartwatches, implantable devices, and dedicated computers. The terminal devices 10 may automatically or manually acquire users' biometric information. In the present embodiment, it is assumed that the event that is held at the event venue is a sports game. However, the event is not limited to this example and may be any event. In the following description, it is assumed that the users of the terminal devices 10 are spectators who are planning on visiting the event venue.

The information processing device 20 is, for example, a server device. However, the information processing device 20 is not limited to the server device, and may be any computer. The information processing device 20 is configured to communicate with the terminal devices 10 via the network 40. In the present embodiment, the information processing device 20 determines an operation plan for the vehicles 30.

The vehicles 30 are, for example, motor vehicles. However, the vehicles 30 are not limited to the motor vehicles, and may be any vehicles. The motor vehicles may be, but are not limited to, battery electric vehicles (BEVs), hybrid electric vehicles (HEVs), plug-in hybrid electric vehicles (PHEVs), or fuel cell electric vehicles (FCEVs). The vehicles 30 may be configured to be driven directly or remotely by a driver. Alternatively, the vehicles 30 may be configured to be driven at, for example, Levels 1 to 5 of driving automation defined by the Society of Automotive Engineers (SAE). The system 1 may include any number of vehicles 30 equal to or greater than two. In the present embodiment, the vehicles 30 transport spectators to the event venue according to the operation plan determined by the information processing device 20.

An overview of the present embodiment will be given first, and details of the present embodiment will be given later. The information processing device 20 acquires biometric information of each of a plurality of spectators who is going to visit an event venue. Based on the biometric information, the information processing device 20 determines an operation plan for one or more vehicles 30 to transport the spectators to and/or from the event venue.

As described above, according to the present embodiment, a plurality of spectators who is going to visit an event venue is transported to or from the event venue by the vehicle(s) 30 according to an operation plan determined based on biometric information of each spectator. The spectators ride in the vehicle(s) 30 that travels according to the operation plan determined based on the biometric information. The spectators' user experiences are thus improved. For example, when the spectators are tired on the way to the event venue, the vehicle cabin environment is set so as to facilitate their recovery from fatigue. The user experiences of the spectators who are traveling to the event venue are thus improved. Accordingly, the technology for transporting users who are going to visit an event venue is improved in that the user experiences of the spectators who are traveling to and/or from the event venue are improved.

Next, the configurations of the system 1 will be described in detail.

### Configuration of Terminal Device

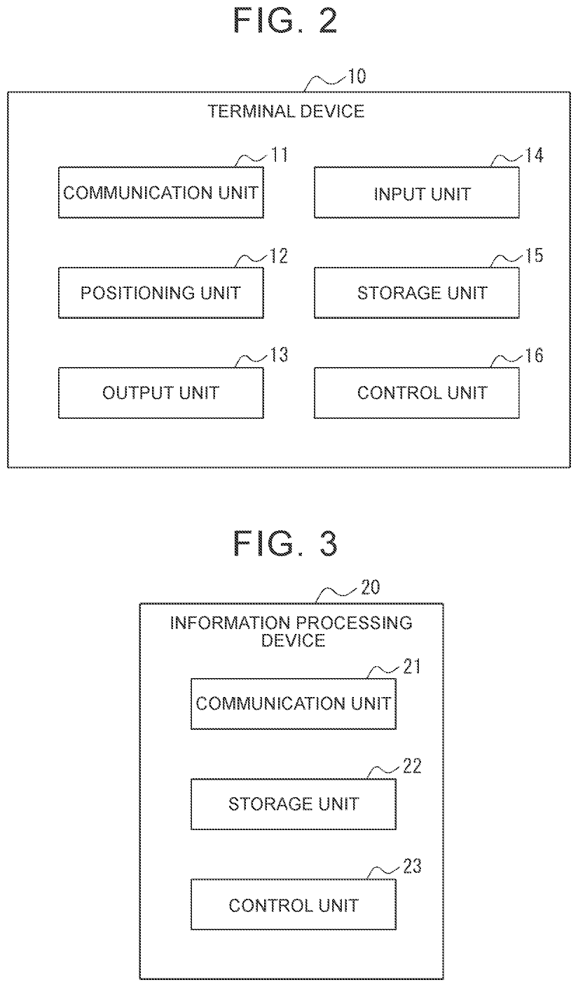

As shown in FIG. 2, the terminal device 10 includes a communication unit 11, a positioning unit 12, an output unit 13, an input unit 14, a storage unit 15, and a control unit 16.

The communication unit 11 includes one or more communication interfaces for connecting to the network 40. The communication interface supports, for example, a mobile communication standard such as fourth generation (4G) or fifth generation (5G), a wired local area network (LAN) standard, or a wireless LAN standard. However, the supported standard is not limited to these, and the communication interface may support any communication standard. In the present embodiment, the terminal device 10 communicates with the information processing device 20 via the communication unit 11 and the network 40.

The positioning unit 12 includes one or more devices that acquire location information of the terminal device 10. Specifically, the positioning unit 12 includes, for example, a receiver compatible with a Global Positioning System (GPS). However, the receiver is not limited to this, and the positioning unit 12 may include a receiver compatible with any satellite positioning system. When the terminal device 10 is a mobile terminal that can be carried by the user, the location information of the terminal device 10 may be treated as location information of the user.

The output unit 13 may include one or more output devices that output information to notify the user. The output device may be, but is not limited to, a display that outputs information in the form of images or a speaker that outputs information in the form of audio. The output unit 13 may include an interface for connecting an external output device.

The input unit 14 may include one or more input devices that detect user input. The input device may be, but is not limited to, a physical key, a capacitive key, a touch screen integrated with a display, a microphone that receives voice input, or a camera. The input unit 14 may include an interface for connecting an external input device.

The storage unit 15 includes one or more memories. The memory may be, but is not limited to, a semiconductor memory, a magnetic memory, or an optical memory. Each memory included in the storage unit 15 may function as, for example, a main storage device, an auxiliary storage device, or a cache memory. The storage unit 15 stores any information to be used for the operation of the terminal device 10. For example, the storage unit 15 may store a system program, an application program, and embedded software. The information stored in the storage unit 15 may be updatable with, for example, information acquired from the network 40 via the communication unit 11.

The control unit 16 includes one or more processors, one or more programmable circuits, one or more dedicated circuits, or a combination thereof. The processor may be, but is not limited to, a general-purpose processor such as a central processing unit (CPU) or a graphics processing unit (GPU), or a dedicated processor specialized for a specific process. The programmable circuit may be, but is not limited to, a field-programmable gate array (FPGA). The dedicated circuit may be, but is not limited to, an application specific integrated circuit (ASIC). The control unit 16 controls the overall operation of the terminal device 10.

### Configuration of Information Processing Device

As shown in FIG. 3, the information processing device 20 includes a communication unit 21, a storage unit 22, and a control unit 23.

The communication unit 21 includes one or more communication interfaces for connecting to the network 40. The communication interface supports, for example, a mobile communication standard, a wired LAN standard, or a wireless LAN standard. However, the supported standard is not limited to these, and the communication interface may support any communication standard. In the present embodiment, the information processing device 20 communicates with the terminal devices 10 via the communication unit 21 and the network 40.

The storage unit 22 includes one or more memories. Each memory included in the storage unit 22 may function as, for example, a main storage device, an auxiliary storage device, or a cache memory. The storage unit 22 stores any information to be used for the operation of the information processing device 20. For example, the storage unit 22 may store a system program, an application program, a database, map information, and biometric information. The information stored in the storage unit 22 may be updatable with, for example, information acquired from the network 40 via the communication unit 21.

The control unit 23 includes one or more processors, one or more programmable circuits, one or more dedicated circuits, or a combination thereof. The control unit 23 controls the overall operation of the information processing device 20.

### Configuration of Vehicle

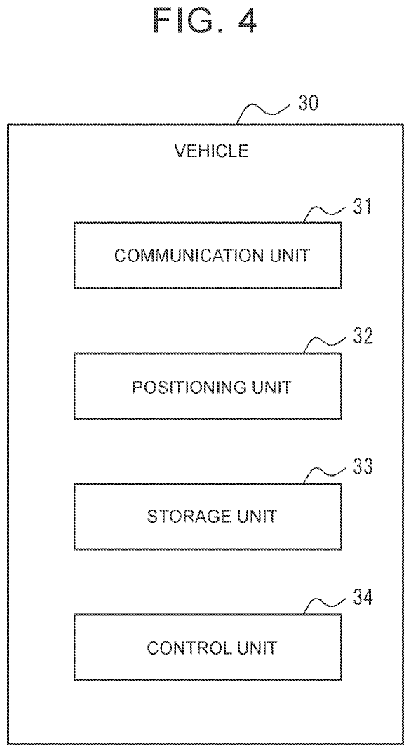

As shown in FIG. 4, the vehicle 30 includes a communication unit 31, a positioning unit 32, a storage unit 33, and a control unit 34.

The communication unit 31 includes one or more communication interfaces for connecting to the network 40. The communication interface supports, for example, a mobile communication standard, but the supported standard is not limited to this. In the present embodiment, the vehicle 30 communicates with the information processing device 20 via the communication unit 31 and the network 40.

The positioning unit 32 includes one or more devices that acquire location information of the vehicle 30. Specifically, the positioning unit 32 includes, for example, a receiver compatible with a GPS. However, the receiver is not limited to this, and the positioning unit 32 may include a receiver compatible with any satellite positioning system.

The storage unit 33 includes one or more memories. Each memory included in the storage unit 33 may function as, for example, a main storage device, an auxiliary storage device, or a cache memory. The storage unit 33 stores any information to be used for the operation of the vehicle 30. For example, the storage unit 33 may store a system program, an application program, embedded software, and map information. The information stored in the storage unit 33 may be updatable with, for example, information acquired from the network 40 via the communication unit 31.

The control unit 34 includes one or more processors, one or more programmable circuits, one or more dedicated circuits, or a combination thereof. The control unit 34 controls the overall operation of the vehicle 30, including adjustment of the vehicle cabin environment such as lighting or temperature inside the vehicle 30.

### Operation Flow of Information Processing Device

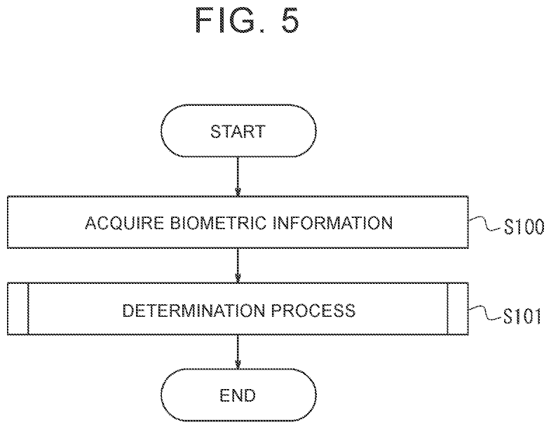

The operation of the information processing device 20 according to the present embodiment will be described with reference to FIG. 5.

Step S100: The control unit 23 of the information processing device 20 acquires biometric information of each of a plurality of spectators who is going to visit an event venue.

Specifically, the control unit 23 acquires biometric information of each spectator who is going to visit the event venue for an event with a fixed date etc. and/or each spectator who is going to go home or head to another place from the event venue.

The biometric information may include any information regarding each spectator. In the present embodiment, the biometric information includes information indicating the level of fatigue of each spectator who is going to visit the event venue. The level of fatigue refers to a numerical value indicating how tired each spectator is. The level of fatigue may be manually entered by the spectator through the input unit 14 of the terminal device 10, or may be automatically calculated from various pieces of information including the body temperature, sweat rate, respiratory rate, blood pressure, and heart rate detected by sensors of the terminal device 10. Any method can be used in addition to the above methods.

Any method can be used to acquire the biometric information. For example, the terminal device 10 may include a sensor. Alternatively, the terminal device 10 may communicate with an external device including a sensor. The control unit 23 of the information processing device 20 may acquire the biometric information entered to the terminal device 10 by the spectator or detected by the sensor of the terminal device 10 by receiving that biometric information via the communication unit 21 and the network 40.

The biometric information is acquired, for example, in the morning of the event date or when the spectator is waiting for the vehicle 30 at a pickup location. However, the timing to acquire the biometric information is not limited to these, and the biometric information may be acquired at any time. The acquired information may be updatable by the spectator or the terminal device 10.

Step S101: The control unit 23 performs a determination process of determining an operation plan for one or more vehicles 30 to transport the spectators to and/or from the event venue, based on the biometric information.

The operation plan for the one or more vehicles 30 to transport the spectators is determined by performing the determination process. In the determination process, the control unit 23 sets the vehicle cabin environment etc. for during traveling of each vehicle 30 transporting the spectators, based on the level of fatigue included in the biological information of each spectator. A specific example of the determination process will be described later. The control unit 34 adjusts the vehicle cabin environment etc. of the vehicle 30 based on this setting.

The operation plan may include any information regarding the operation of the vehicles 30. For example, the operation plan includes information associating each vehicle 30, the driver of the vehicle 30, and the spectators who are supposed to ride in the vehicle 30 with each other, information on the vehicle cabin environment of each vehicle 30, and information on the content to be played in each vehicle 30. The information on the vehicle cabin environment of the vehicle 30 includes, for example, information indicating lighting, temperature, and humidity. However, the information on the vehicle cabin environment of the vehicle 30 is not limited to these, and may include any information on the vehicle cabin environment of the vehicle 30.

### First Example of Determination Process

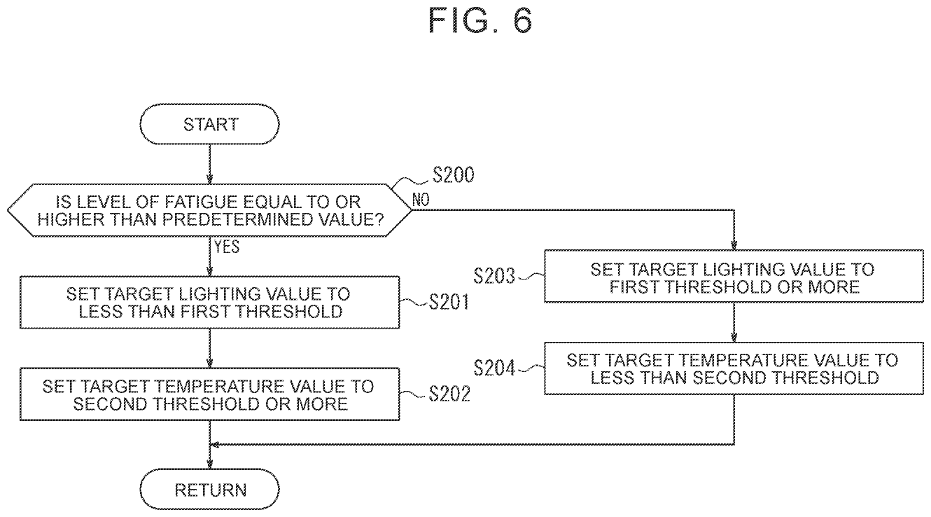

A first example of the determination process in step S101 will be described with reference to FIG. 6. As described above, in the first example, the biometric information includes information on the level of fatigue.

Step S200: The control unit 23 acquires information on the level of fatigue of each spectator from the biological information acquired in step S100, and determines whether the level of fatigue is equal to or higher than a predetermined value.

Step S201: When it is determined that the level of fatigue is equal to or higher than the predetermined value, the control unit 23 sets a target lighting value in the vehicle cabin for during traveling of each vehicle 30 to less than a first threshold. Based on this setting, the control unit 34 of each vehicle 30 makes an adjustment so that the brightness of lighting in the vehicle cabin is less than the target lighting value during traveling of the vehicle 30.

Step S202: After step S201, the control unit 23 sets a target temperature value in the vehicle cabin for during traveling of each vehicle 30 to a second threshold or more. Based on this setting, the control unit 34 of each vehicle 30 makes an adjustment so that the temperature in the vehicle cabin is the target temperature value or more during traveling of the vehicle 30.

When the level of fatigue of the spectator is equal to or higher than the predetermined value, that is, when the spectator is tired, the vehicle cabin of the vehicle 30 is darkened by step S201 and heated by step S202 during traveling of the vehicle 30. It is therefore possible to provide an environment in which the spectator can relax and recover from fatigue while he or she is traveling to and/or from the event venue. Steps S200 to S202 and the adjustment of the vehicle cabin by the vehicle 30 may be performed simultaneously, or may be performed separately at any timings. The first threshold and the second threshold may be any values, and may be determined based on the area where the vehicle 30 travels, the season, the time of day, the environment outside the vehicle 30, etc. However, the first threshold and the second threshold may be determined by any other method.

Step S203: When it is determined that the level of fatigue is less than the predetermined value, the control unit 23 sets the target lighting value in the vehicle cabin for during traveling of each vehicle 30 to the first threshold or more. Based on this setting, the control unit 34 of each vehicle 30 makes an adjustment so that the brightness of lighting in the vehicle cabin is the target lighting value or more during traveling of the vehicle 30.

Step S204: After step S203, the control unit 23 sets the target temperature value in the vehicle cabin for during traveling of each vehicle 30 to less than the second threshold. Based on this setting, the control unit 34 of each vehicle 30 makes an adjustment so that the temperature in the vehicle cabin is less than the target temperature value during traveling of the vehicle 30.

When the level of fatigue of the spectator is less than the predetermined value, that is, when the spectator is not tired, the vehicle cabin of the vehicle 30 is brightened by step S203 and cooled by step S204 during traveling of the vehicle 30. It is therefore possible to provide an environment in which the spectator can feel excited while he or she is traveling to and/or from the event venue.

As described above, according to the determination process of the first example, it is determined in step S200 whether the level of fatigue of each spectator is equal to or higher than the predetermined value, and based on the level of fatigue, the vehicle cabin environment for during traveling of the vehicle 30 is set in steps S201 to S204. An appropriate vehicle cabin environment is thus provided according to the level of fatigue of each spectator, and the spectators' event experiences are improved.

### Second Example of Determination Process

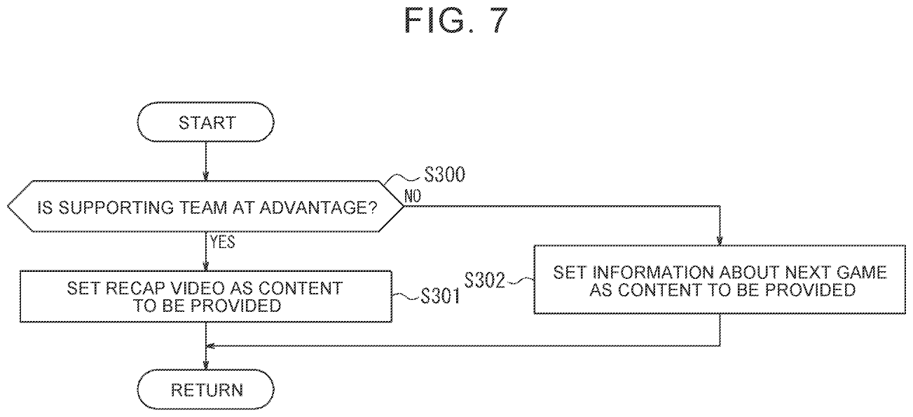

A second example of the determination process in step S101 will be described with reference to FIG. 7. The second example is a modification that is applied to watching a sports game. In this modification, the control unit 23 determines an operation plan for the return trip based on a combination of the biometric information and the game situation. After it is determined in step S200 of the first example that the level of fatigue is less than the predetermined value, the control unit 23 performs the following steps. In the second example, it is assumed that the event venue is a venue for a sports game. In the second example, it is also assumed that the spectators are going to go home after watching the sports game.

Step S300: The control unit 23 acquires information indicating a supporting team set as a team each spectator roots for out of the teams participating in the sports game, and determines whether the supporting team is at an advantage.

Any method can be used to acquire the information indicating the supporting team. The supporting team being at an advantage refers to, for example, a situation where the score of the supporting team is higher than the score of the opposing team during the game, or a situation where the supporting team actually won the game. The supporting team not being at an advantage, that is, being at a disadvantage, refers to, for example, a situation where the score of the supporting team is lower than the score of the opposing team during the game, or a situation where the supporting team actually lost the game. In the present embodiment, it is assumed that this determination is made in the final stage of the game. However, this determination may be made at any other timing. Whether the supporting team is at an advantage may be determined based on any conditions including the difference in score between the teams.

Step S301: When it is determined that the supporting team is at an advantage, the control unit 23 sets a recap video of the game the spectators watched as the content to be provided in the vehicle 30. Based on this setting, the control unit 34 of each vehicle 30 plays the recap video in the vehicle 30 during the return trip.

The recap video includes any video regarding the game the spectators watched, such as highlights of the game. Showing the recap video to each spectator who has a low level of fatigue and is excited at the win of the supporting team maintains his or her excitement and enthusiasm even during the return trip.

Step S302: When it is determined that the supporting team is at a disadvantage, the control unit 23 sets information about the next game as the content to be provided in the vehicle 30. Based on this setting, the control unit 34 of each vehicle 30 provides the information about the next game in the vehicle 30 during the return trip.

The information about the next game includes information about the schedule, opposing team, and venue of the game the supporting team is going to play on the following day or a later day. Providing the information about the next game to each spectator who has a low level of fatigue but is disappointed by the loss of the supporting team increases his or her motivation to root for the supporting team in the next game.

As described above, according to the determination process of the second example, it is determined in step S300 whether the supporting team is at an advantage, and based on whether the supporting team is at an advantage or at a disadvantage, the content to be provided in each vehicle 30 during the return trip is set in steps S301 and S302. An environment in which the spectators can enjoy themselves even during their return trip can thus be provided, which improves the spectators' event experiences.

Even for those spectators whose level of fatigue is determined to be equal to or higher than the predetermined value in step S200, the control unit 23 may determine whether the supporting team is at an advantage. When the control unit 23 determines that the supporting team is at a disadvantage, the control unit 23 may recommend those spectators to leave the event venue before the game ends. This recommendation may be made at any time. The control unit 34 may then control the vehicle 30 so that the vehicle 30 leaves the event venue before the game ends. Those spectators who have a high level of fatigue and whose supporting team is at a disadvantage often leave the venue immediately after the game ends or without waiting for the game to end. Making such a recommendation to such spectators helps relieve congestion.

As described above, the information processing device 20 acquires biometric information of each of a plurality of spectators who is going to visit an event venue. Based on the biometric information, the information processing device 20 determines an operation plan for one or more vehicles 30 to transport the spectators to and/or from the event venue.

According to this configuration, a plurality of spectators who is going to visit an event venue is transported to or from the event venue by the vehicle(s) 30 according to an operation plan determined based on biometric information of each spectator. The spectators ride in the vehicle(s) 30 that travels according to the operation plan determined based on the biometric information. The spectators' user experiences are thus improved. For example, when the spectators are tired on the way to the event venue, the vehicle cabin environment is set so as to facilitate their recovery from fatigue. The user experiences of the spectators who are traveling to the event venue are thus improved. Accordingly, the technology for transporting users who are going to visit an event venue is improved in that the user experiences of the spectators who are traveling to and/or from the event venue are improved.

Although the present disclosure is described above based on the drawings and the embodiment, it should be noted that those skilled in the art may make various modifications and alterations thereto based on the present disclosure. It should therefore be understood that these modifications and alterations are within the scope of the present disclosure. For example, the functions included in the configurations, steps, etc. can be rearranged as long as no logical inconsistency arises, and a plurality of configurations, steps, etc. can be combined into one or divided into two or more.

For example, in the above embodiment, the configuration and operation of the information processing device 20 may be distributed between or among a plurality of computers configured to communicate with each other. Embodiments are also possible in which part or all of the components of the information processing device 20 are provided in the terminal device 10.

In the above embodiment, the operation flow of the information processing device 20 is divided into steps S100 to S101, S200 to S204, and S300 to S302. However, embodiments in which part of the steps is combined or omitted are also possible. For example, the control unit 23 may perform both steps S203 to S204 and steps S300 to S302.

The above embodiment may be modified so that the biometric information is used to assign a plurality of spectators to a plurality of vehicles 30.

For example, the biometric information includes information indicating the level of fatigue of each spectator. The control unit 23 may determine an operation plan so that those spectators having approximately the same level of fatigue are transported by the same vehicle 30. For example, when a plurality of spectators who is going home is to be transported by a plurality of vehicles 30 after a sports game ends, the control unit 23 acquires their levels of fatigue and assign those spectators having approximately the same level of fatigue to the same vehicle 30. According to this configuration, those spectators having closer levels of fatigue ride in the same vehicle 30. It is therefore possible to provide the vehicle cabin environment that is more suitable for each spectator. The spectators' user experiences are thus improved.

For example, an embodiment is also possible in which a general-purpose computer functions as the information processing device 20 according to the above embodiment. Specifically, a program describing processing for implementing each function of the information processing device 20 according to the above embodiment is stored in a memory of the general-purpose computer, and the program is read and executed by the processor. Therefore, the present disclosure can also be implemented as a program that is executable by the processor or a non-transitory computer-readable medium that stores the program.

In the above embodiment, the vehicles 30 may be autonomous vehicles that do not need to be driven by a driver. In such a case, the control unit 23 of the information processing device 20 may control autonomous driving of each vehicle 30 by sending to each vehicle 30 an instruction to operate according to the determined operation plan.

What is claimed is:

1. A method that is performed by an information processing device, the method comprising:
acquiring biometric information of each of a plurality of spectators who is going to visit an event venue; and
determining, based on the biometric information, an operation plan for one or more vehicles to transport the spectators to or from the event venue, or to and from the event venue.

2. The method according to claim 1, wherein:
the biometric information includes information indicating a level of fatigue of the spectator; and
the information processing device is configured to determine the operation plan in such a manner that the spectators having approximately the same level of fatigue are transported by the same vehicle.

3. The method according to claim 2, wherein the information processing device is configured to determine the operation plan in such a manner that, when the level of fatigue of the spectator is equal to or higher than a predetermined value, the information processing device performs either or both of the following settings: setting a target lighting value in a vehicle cabin for during traveling of each vehicle to less than a first threshold, and setting a target temperature value in the vehicle cabin for during traveling of each vehicle to a second threshold or more.

4. The method according to claim 2, wherein the information processing device is configured to determine the operation plan in such a manner that, when the level of fatigue of the spectator is less than a predetermined value, the information processing device performs either or both of the following settings: setting a target lighting value in a vehicle cabin for during traveling of each vehicle to a first threshold or more, and setting a target temperature value in the vehicle cabin for during traveling of each vehicle to less than a second threshold.

5. The method according to claim 2, further comprising:
acquiring information indicating a supporting team set as a team the spectator roots for out of teams participating in a sports game that is held at the event venue; and
when the level of fatigue of the spectator is high and the supporting team is at a disadvantage in the game, recommending the spectator to leave the event venue before the game ends.

6. The method according to claim 2, further comprising acquiring information indicating a supporting team set as a team the spectator roots for out of teams participating in a sports game that is held at the event venue, wherein
the information processing device is configured to determine the operation plan in such a manner that, when the level of fatigue of the spectator is low and the supporting team is at an advantage in the game or won the game, a recap video of the game is played during a return trip.

7. The method according to claim 2, further comprising acquiring information indicating a supporting team set as a team the spectator roots for out of teams participating in a sports game that is held at the event venue, wherein the information processing device is configured to determine the operation plan in such a manner that, when the level of fatigue of the spectator is low and the supporting team is at a disadvantage in the game or lost the game, content about a next game of the supporting team is provided during a return trip in each vehicle.

8. A non-transitory storage medium storing instructions that are executable by one or more processors and that cause the one or more processors to perform functions comprising:
acquiring biometric information of each of a plurality of spectators who is going to visit an event venue; and
determining, based on the biometric information, an operation plan for one or more vehicles to transport the spectators to or from the event venue, or to and from the event venue.

9. The non-transitory storage medium according to claim 8, wherein the biometric information includes information indicating a level of fatigue of the spectator, the functions further comprising determining the operation plan in such a manner that the spectators having approximately the same level of fatigue are transported by the same vehicle.

10. The non-transitory storage medium according to claim 9, the functions further comprising determining the operation plan in such a manner that, when the level of fatigue of the spectator is equal to or higher than a predetermined value, either or both of the following settings are performed: a target lighting value in a vehicle cabin for during traveling of each vehicle is set to less than a first threshold, and a target temperature value in the vehicle cabin for during traveling of each vehicle is set to a second threshold or more.

11. The non-transitory storage medium according to claim 9, the functions further comprising determining the operation plan in such a manner that, when the level of fatigue of the spectator is less than a predetermined value, either or both of the following settings are performed: a target lighting value in a vehicle cabin for during traveling of each vehicle is set to a first threshold or more, and a target temperature value in the vehicle cabin for during traveling of each vehicle is set to less than a second threshold.

12. The non-transitory storage medium according to claim 9, the functions further comprising:
acquiring information indicating a supporting team set as a team the spectator roots for out of teams participating in a sports game that is held at the event venue; and
when the level of fatigue of the spectator is high and the supporting team is at a disadvantage in the game, recommending the spectator to leave the event venue before the game ends.

13. The non-transitory storage medium according to claim 9, the functions further comprising:
acquiring information indicating a supporting team set as a team the spectator roots for out of teams participating in a sports game that is held at the event venue; and
determining the operation plan in such a manner that, when the level of fatigue of the spectator is low and the supporting team is at an advantage in the game or won the game, a recap video of the game is played during a return trip.

14. The non-transitory storage medium according to claim 9, the functions further comprising:
acquiring information indicating a supporting team set as a team the spectator roots for out of teams participating in a sports game that is held at the event venue; and
determining the operation plan in such a manner that, when the level of fatigue of the spectator is low and the supporting team is at a disadvantage in the game or lost the game, content about a next game of the supporting team is provided during a return trip in each vehicle.

15. An information processing device, comprising a control unit, wherein the control unit is configured to
acquire biometric information of each of a plurality of spectators who is going to visit an event venue, and
determine, based on the biometric information, an operation plan for one or more vehicles to transport the spectators to or from the event venue, or to and from the event venue.

16. The information processing device according to claim 15, wherein:
the biometric information includes information indicating a level of fatigue of the spectator; and
the control unit is configured to determine the operation plan in such a manner that the spectators having approximately the same level of fatigue are transported by the same vehicle.

17. The information processing device according to claim 16, wherein the control unit is configured to determine the operation plan in such a manner that, when the level of fatigue of the spectator is equal to or higher than a predetermined value, the control unit performs either or both of the following settings: setting a target lighting value in a vehicle cabin for during traveling of each vehicle to less than a first threshold, and setting a target temperature value in the vehicle cabin for during traveling of each vehicle to a second threshold or more.

18. The information processing device according to claim 16, wherein the control unit is configured to determine the operation plan in such a manner that, when the level of fatigue of the spectator is less than a predetermined value, the control unit performs either or both of the following settings: setting a target lighting value in a vehicle cabin for during traveling of each vehicle to a first threshold or more, and setting a target temperature value in the vehicle cabin for during traveling of each vehicle to less than a second threshold.

19. The information processing device according to claim 16, wherein the control unit is configured to
acquire information indicating a supporting team set as a team the spectator roots for out of teams participating in a sports game that is held at the event venue, and
determine the operation plan in such a manner that, when the level of fatigue of the spectator is low and the supporting team is at an advantage in the game or won the game, a recap video of the game is played during a return trip.

20. The information processing device according to claim 16, wherein the control unit is configured to
acquire information indicating a supporting team set as a team the spectator roots for out of teams participating in a sports game that is held at the event venue, and
determine the operation plan in such a manner that, when the level of fatigue of the spectator is low and the supporting team is at a disadvantage in the game or lost the game, content about a next game of the supporting team is provided during a return trip in each vehicle.
